(19) United States
(12) Patent Application Publication
(10) Pub. No.: US 2015/0098000 A1
(43) Pub. Date: Apr. 9, 2015

(54) System and Method for Dynamic Image Composition Guidance in Digital Camera

(71) Applicant: FUTUREWEI TECHNOLOGIES, INC., Plano, TX (US)

(72) Inventors: Sreenivasulu Gosangi, San Diego, CA (US); Adam K. Zajac, San Diego, CA (US); Anthony J. Mazzola, Ramona, CA (US)

(73) Assignee: FUTUREWEI TECHNOLOGIES, INC., Plano, TX (US)

(21) Appl. No.: 14/045,568

(22) Filed: Oct. 3, 2013

(51) Int. Cl. H04N 5/232

(52) U.S. Cl. CPC H04N 5/23293
USPC 348/333.02

(57) ABSTRACT

Embodiments are provided for dynamic image composition guidance in digital cameras. The dynamic image composition guidance allows users, for example, amateurs or less experienced photographers, to effectively and properly use photographic composition techniques for improving the quality of digitally captured images. A guidance method on a camera device determines a geometric strength point according to an image composition rule for a scene captured on the camera device. A user of the camera device is then guided in real-time while moving the camera device to align an object of the scene with the geometric strength point before recapturing the scene on the camera device. The method includes displaying, with the geometric strength point, changes to the scene including a moving point associated with a focused object on the first image according to movements of the camera device in real-time.

### TECHNICAL FIELD

The present invention relates to the field of image processing, and, in particular embodiments, to a system and method for dynamic image composition guidance in digital camera.

### BACKGROUND

To make a photograph more appealing, professional photographers apply various photographic or image composition techniques, also referred to as composition rules, such as the rule of thirds, the golden spiral rule, the golden triangles rule, and other image composition techniques or rules. The composition techniques or rules help better arrange the elements of a scene within a picture, for example to catch the viewer's attention, please the eye, or make a clear statement. In general, the composition techniques or rules improve the aesthetic or artistic value of captured pictures. However, in order to reach this goal, the photographer needs to have sufficient knowledge of using and applying such composition techniques. Otherwise, an amateur may not be able to achieve the same aesthetic value in their photographs or captured images. There is a need for a mechanism that allows amateurs or less experienced photographers to effectively or properly use such photographic composition techniques to improve the quality of their photographs.

### SUMMARY OF THE INVENTION

In accordance with an embodiment of the disclosure, a method for dynamic image composition guidance includes determining, on a camera device, a geometric strength point according to an image composition rule for a scene captured on the camera device. The method further includes guiding a user of the camera device while the camera device is moved to align an object of the scene with the geometric strength point before recapturing the scene on the camera device.

In accordance with another embodiment of the disclosure, a method for dynamic image composition guidance includes displaying, on a camera device, a first image captured for a scene. A geometric strength point is then determined for the first image according to an image composition rule. The method further includes displaying the geometric strength point on the first image, and displaying an object point associated with a focused object on the first image. The method further displays changes to the scene in accordance with movements of the camera device with respect to the scene. A second image captured for the scene is then moved displayed after the camera device is moved.

In accordance with another embodiment of the disclosure, a method for operating a camera device with dynamic image composition guidance includes capturing, on the camera device, a first image for a scene, and moving the camera device to align, on a screen of the camera device, an object point in the first image at or close to a geometric strength point fixed on the screen. The object point and the geometric strength point are displayed while moving the camera. The geometric strength point is determined by the camera device according to an image composition rule. The method further includes capturing a second image for the scene after aligning the object with the geometric strength point.

In accordance with yet another embodiment of the disclosure, a device equipped with a camera and configured for real-time image composition guidance includes at least one processor and a non-transitory computer readable storage medium storing programming for execution by the at least one processor. The programming includes instructions to determine a geometric strength point according to an image composition rule for a scene captured by the camera. The programming further configures the device to guide a user of the camera in real-time time while the user moves the device to align an object of the scene with the geometric strength point before recapturing the scene on the device.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates images before and after dynamic image composition guidance in a camera device according to an embodiment of the disclosure;

FIG. 2 illustrates more images before and after dynamic image composition guidance in a camera device according to another embodiment of the disclosure;

FIG. 3 illustrates more images before and after dynamic image composition guidance in a camera device according to another embodiment of the disclosure; and

FIG. 4 illustrates an embodiment method for dynamic image composition guidance in a camera device;

FIG. 5 illustrates an embodiment architecture for implementing dynamic image composition guidance in a camera device;

FIG. 6 illustrates another embodiment architecture for implementing dynamic image composition guidance in a camera device; and

FIG. 7 is a diagram of a processing system that can be used to implement various embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Embodiments are provided herein for dynamic image composition guidance in digital cameras. The dynamic image composition guidance allows users, for example, amateurs or less experienced photographers, to effectively and properly use photographic composition techniques for improving the quality of digitally captured images. The dynamic guidance system can be implemented using software/hardware in a digital camera or any device capable of capturing pictures, such as a smartphone. Upon capturing an image, the dynamic guidance system displays to the user a geometric composition template over the captured image. The display also shows geometric strength points on the image. The geometric strength points are intended to dynamically guide the user, e.g., in real-time, to redirect the camera's angle (or the camera's lens) to align an element or object of the scene within the geometric composition template according to the selected composition rule, and retake the picture accordingly. Specifically, the geometric strength points correspond to intersection points of template lines arranged according to the composition rule. The geometric composition template and geometric strength points are determined by the dynamic guidance system according to a photographic composition rule to improve the aesthetics of the image. The photographic composition rule may be selected from a plurality of available image composition techniques supported by the camera device. The composition rule may be selected by the user or automatically by the camera device, e.g., according to camera settings or photographic conditions such as focus, amount of light, scene type, or selected photography mode. Examples of some of the composition rules and how they may be applied using the guidance system are presented below. Other composition rules/techniques may also be implemented similarly using image composition guidance.

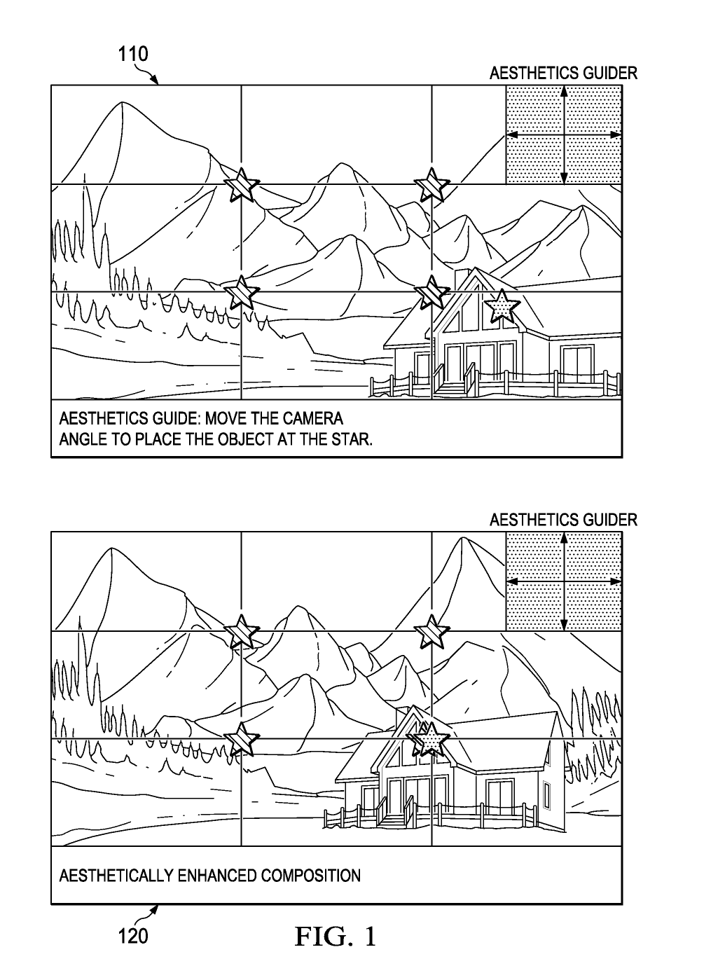

FIG. 1 shows embodiment images before and after dynamic image composition guidance in a camera device. The images include a first image 110 for a scene captured before applying a photographic composition rule, and a second image 120 for the same scene with improved aesthetics captured after applying the composition rule. Specifically, the composition rule or technique used in this example is the rule of thirds. The rule of thirds is a “rule of thumb” or guideline which proposes that an image should be imagined as divided into nine equal parts by two equally-spaced horizontal lines and two equally-spaced vertical lines. Accordingly, important compositional elements of the image are placed along these lines or their intersections. Aligning an element of the image or scene with these points can create more tension, energy, and interest in the composition, e.g., in comparison to simply centering the element in the middle of the scene.

After capturing the first image 110, the dynamic guidance system applies the rules of thirds to the image. The first image 110 is displayed to the user on the camera device, e.g., on the display of a smartphone or a viewing screen of a digital camera. The system also displays the geometric composition template for the rule of thirds on the first image 110. According to the rule of thirds, the template is divided into 9 equal rectangles as shown in FIG. 1. The system also displays on the first image 110 a plurality of geometric strength points determined according to the rules of thirds. The geometric strength points correspond to four stress points displayed at the intersections of the horizontal and vertical lines of the template. The system also shows a point on a focused element or object in the captured scene, which is a building structure in the first image 110. The points can be represented by stars, as shown in FIG. 1, or by other shapes. A preferred stress point can be selected based on an aesthetic score measured by the system according to the geometric composition rule (the rule of thirds). The focus object and selected stress point may be differentiated from the other points. For example, the stars representing the focused object and the selected stress point may have different colors than the other stress points. Alternatively, the focus object and selected stress point may be represented using different shapes than the other points, e.g., circles or diamonds instead of stars. A message may also be displayed, e.g., at the bottom of the screen, to instruct the user to move the camera device in order to place or align the object at or close to the selected stress point. The user may also align the focused object with any of the other geometric strength points.

When the user moves or changes the angle of the camera, the position of the object (the building structure) with respect to the scene is shifted accordingly, in real-time, while the positions of the strength points and the template remain fixed. This is displayed, in real-time, in the viewer screen. A movement guider (labeled aesthetics guider in FIG. 1) may also be displayed (e.g., at the top right corner of the view screen) to help the user move the camera in the proper direction to align the object properly within the template. The movement guider reflects movements of the camera device in real-time with respect to horizontal and vertical axis on the screen viewer. The user can thus align the object with the selected stress point, as shown in the second image 120, or alternatively with any of the other points. The user can then capture the new image, which is expected to have improved aesthetics after applying the rule of thirds.

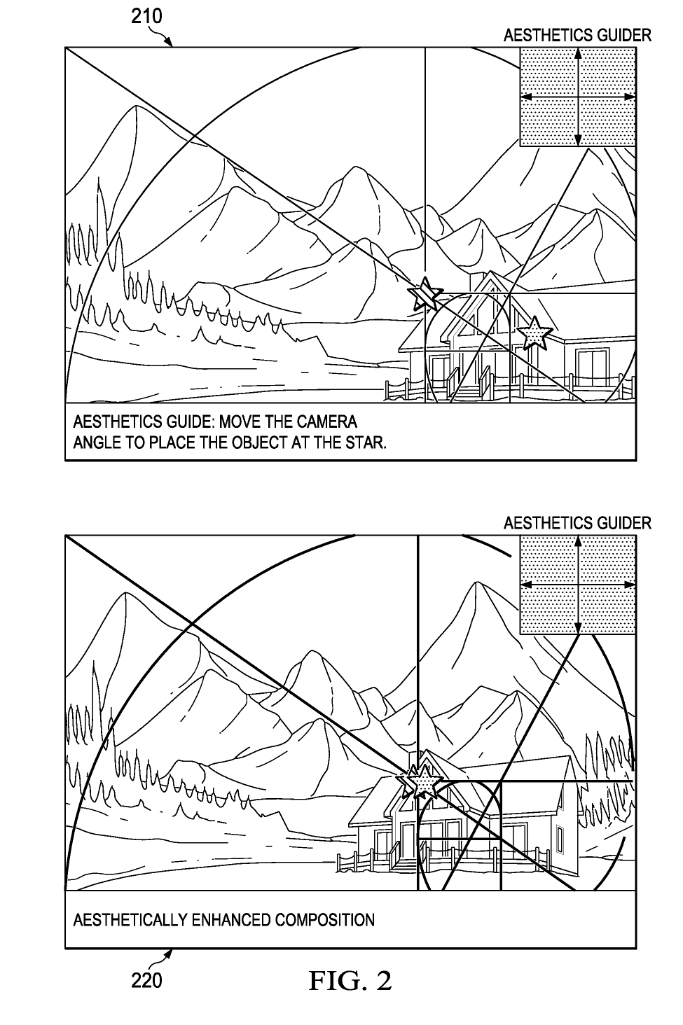

FIG. 2 shows more embodiment images before and after dynamic image composition guidance in a camera device. The images include a first image 210 for a scene captured before applying another photographic composition rule, specifically the golden spiral rule. A second image 220 for the same scene with improved aesthetics is also captured after applying this composition rule. According to the golden spiral rule, a spiral is used to align elements or objects of an image, with the intention to lead the eye to a point or to better align the elements and enhance the image aesthetics.

After capturing the first image 210, the dynamic guidance system applies the golden spiral rule to the image. The first image 210 is displayed to the user on the camera device with the geometric composition template for the golden spiral rule. The template includes a spiral that winds down to a point and other lines aligned with the spiral, as shown in FIG. 2. Additionally, the system displays a geometric strength point determined at the intersection between the spiral and other lines of the template. The point may be selected at the intersection of the vertical and other lines of the template. This stress point can be selected based on an aesthetic score measured by the system according to the geometric composition rule (the golden spiral rule). The system also displays a point representing a focused element or object in the scene, which is a building structure in the first image 210. The points can be represented by stars, as shown in FIG. 2, or by other shapes or indicators. A message may also be displayed, e.g., at the bottom of the screen, to instruct the user to move the camera device to align the object with (e.g., place the object at or close to) the selected stress point.

When the user moves or changes the angle of the camera, the position of the object (the building structure) with respect to the scene is shifted accordingly, while the positions of the strength point and the template remain fixed. This is displayed, in real-time, in the viewer screen. An aesthetics guider may also be displayed (e.g., at the top right corner of the view screen) to help the user move the camera in the proper direction to align the object properly. The user can thus align the object with the selected stress point, as shown in the second image 220. The user can then capture the new image, which is expected to have improved aesthetics after applying the golden spiral rule.

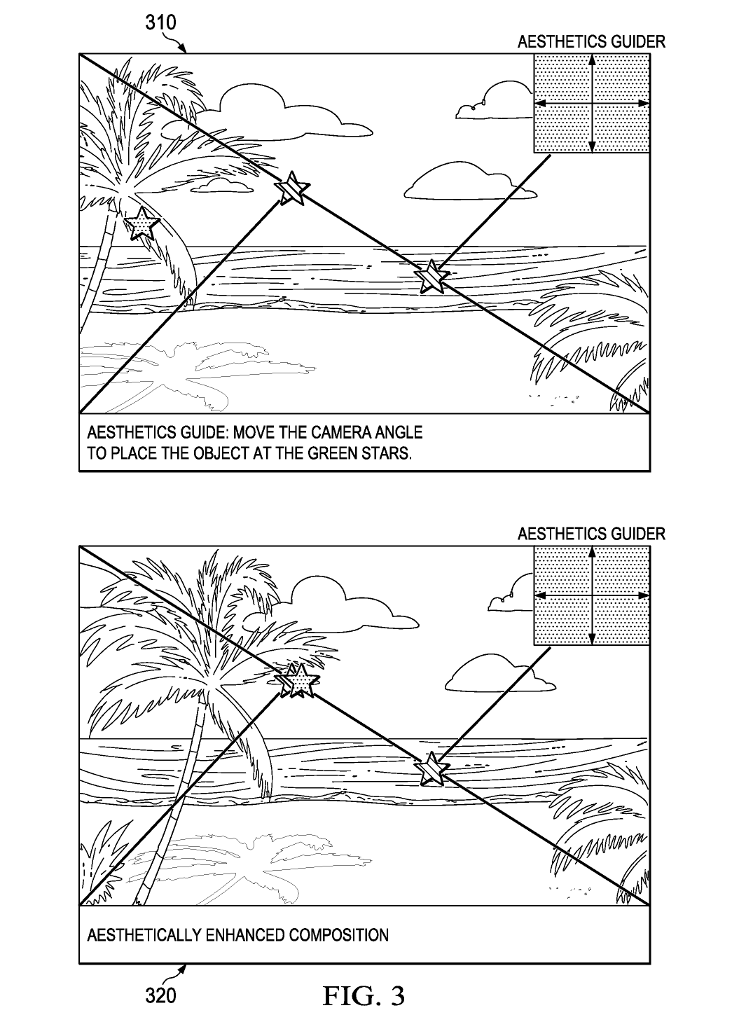

FIG. 3 shows more embodiment images before and after dynamic image composition guidance in a camera device. The images include a first image 310 for a scene captured before applying another photographic composition rule, specifically the golden triangles rule. A second image 320 for the same scene is captured with improved aesthetics after applying this composition rule. The golden triangles rule may be more convenient for photos with diagonal arrangement of elements, for example. According to the golden triangles rule, the scene is divided into multiple triangles intended for roughly placing objects of a picture within or for aligning the objects with the intersection of the triangle lines.

After capturing the first image 310, the dynamic guidance system applies the golden triangles rule to the image. The first image 310 is displayed to the user on the camera device with the geometric composition template for the golden triangles rule. The template may include four triangles that split the image, as shown in FIG. 3. Additionally, the system displays two geometric strength points determined at the intersections of the triangle lines. A preferred stress point can be selected based on an aesthetic score measured by the system according to the geometric composition rule (the triangles rule). The system also displays a point representing a focused element or object in the scene, which is a tree in the first image 310. The points can be represented by stars, as shown in FIG. 3, or by other shapes or indicators. The focus object and selected stress point may be differentiated from the other points. For example, the stars representing the focused object and the selected stress point may have different colors than the other stress point. Alternatively, the focus object and selected stress point may be represented using different shapes than the other point, e.g., circles or diamonds instead of stars. A message may also be displayed, e.g., at the bottom of the screen, to instruct the user to move the camera device to align the object with (e.g., place the object at or close to) the selected stress point. The user may also align the focused object with the other geometric strength point.

When the user moves or changes the angle of the camera, the position of the object (the tree) with respect to the scene is shifted accordingly, while the positions of the strength points and the template remain fixed. This is displayed, in real-time, in the viewer screen. An aesthetics guider may also be displayed (e.g., at the top right corner of the view screen) to help the user move the camera in the proper direction to align the object properly. The user can thus align the object with the selected stress point, as shown in the second image 320. The user can then capture the new image, which is expected to have improved aesthetics after applying the golden triangles rule. The image composition rules above can be available or used at the same camera device and are presented herein as examples. Additional or other image composition rules or techniques may also be selected and used similarly at the same camera device to improve image aesthetics.

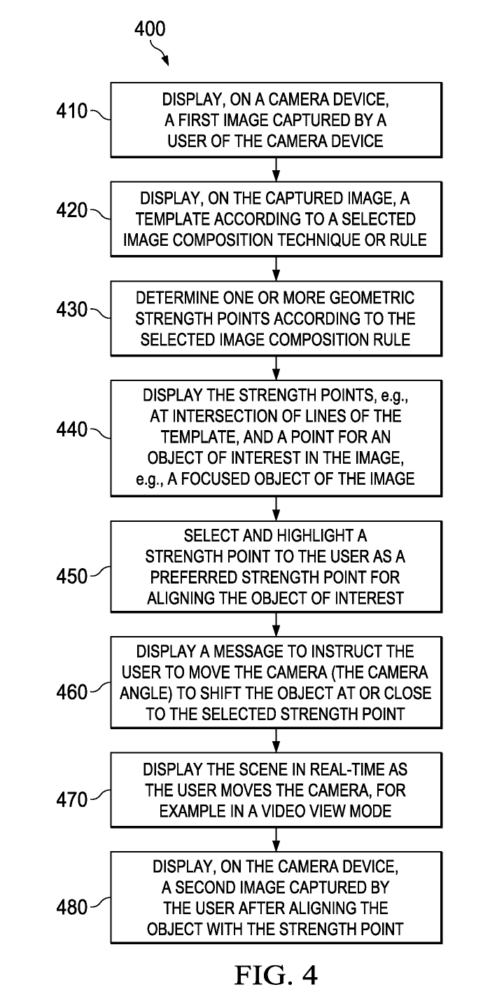

FIG. 4 is a flow diagram of an embodiment method 400 for dynamic image composition guidance in a camera device. The method 400 may be used to enhance the aesthetics of images captured by a camera device (e.g., a smartphone or a digital camera), for example as shown in the embodiment images above. At step 410, a first image captured by a user of the camera device is displayed on the camera device. At step 420, a template according to a selected image composition technique or rule is displayed on the captured image. The composition rule may be selected by the user as input (from a list of available composition techniques) or automatically by the dynamic image composition guidance system, for example according to image conditions. At step 430, one or more geometric strength points are determined according to the selected image composition rule. At step 440, the strength points are displayed on the image, e.g., at intersection of lines of the template. A point for an object of interest in the image, e.g., a focused object of the image, is also displayed. At step 450, a strength point is selected and highlighted to the user as a preferred strength point for aligning the object of interest. The selected stress point may be determined according to calculated scores for the strength points. At step 460, a message is displayed to instruct the user to move the camera (the camera angle) to shift the object at or close to the selected strength point. At step 470, the scene is displayed in real-time as the user moves the camera, for example in a video view mode. This allows the user to control the camera angle by viewing the screen in order to align the object point (e.g., a star representing the object) with the strength point (e.g., a second star representing the strength point). At step 480, a second image captured by the user after aligning the object with the strength point is displayed on the camera device. The second image is expected to have improved aesthetics in comparison to the first image according to the selected image composition technique or rule.

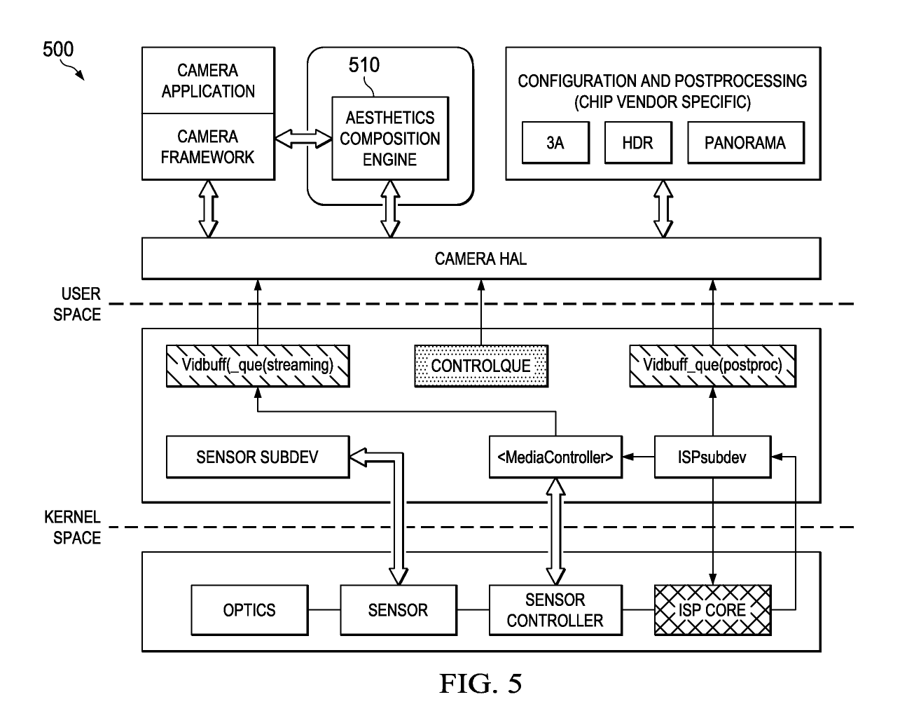

FIG. 5 shows an embodiment of an architecture 500 that can be used for implementing dynamic image composition guidance in a camera device. The architecture 500 includes an aesthetics composition engine 510 that communicates with a camera hardware adaptation layer (HAL) and a camera framework implemented on a camera device (e.g., a smartphone, a computer tablet, or a digital camera). Specifically, the aesthetics composition engine 510 implements, via software for example, the dynamic image composition guidance described above. For instance, the method 400 is implemented by the aesthetics composition engine 510. The camera framework also communicates with the camera HAL and a camera application. The camera HAL also communicates at the user space with imaging functions, such as 3A, high dynamic range (HDR), and Panorama. The camera HAL allows the components above at the user layer, including the aesthetics composition engine 510, to interact with the kernel layer functions, such as Vidbuff, ControlQue, and Vidbuff_Que for Google Android™ Platform or with other kernel layer functions for other functions for other platforms. Other functions of the kernel layer, such as Sensor subdev, MediaController, and ISPsubdev, further interact with the hardware layer modules or devices, such as sensor, sensor controller, and ISP core.

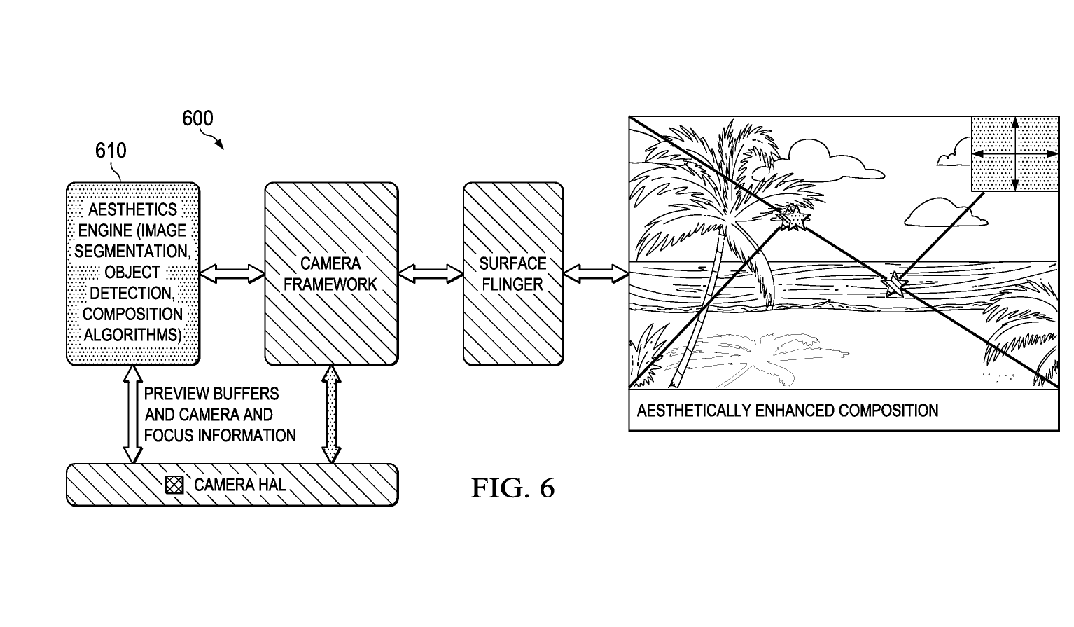

FIG. 6 shows another embodiment of an architecture 600 that can be used for implementing dynamic image composition guidance in a camera device. The architecture 600 includes an aesthetics engine 610 that communicates with a camera HAL and a camera framework that are implemented on a camera device (e.g., a smartphone, a computer tablet, or a digital camera). Specifically, the aesthetics engine 610 implements, via software for example, the dynmaic image composition guidance as described above. The functions implemented by the aesthetics engine 610 may include image segmentation, object detection, composition algorithms, and/or the method 400. The camera framework also communicates with the camera HAL and a camera application (e.g., Surface Flinger) that displays the captured images on the camera device. For example, these components communicate with each other to preview buffers, camera, and focus information.

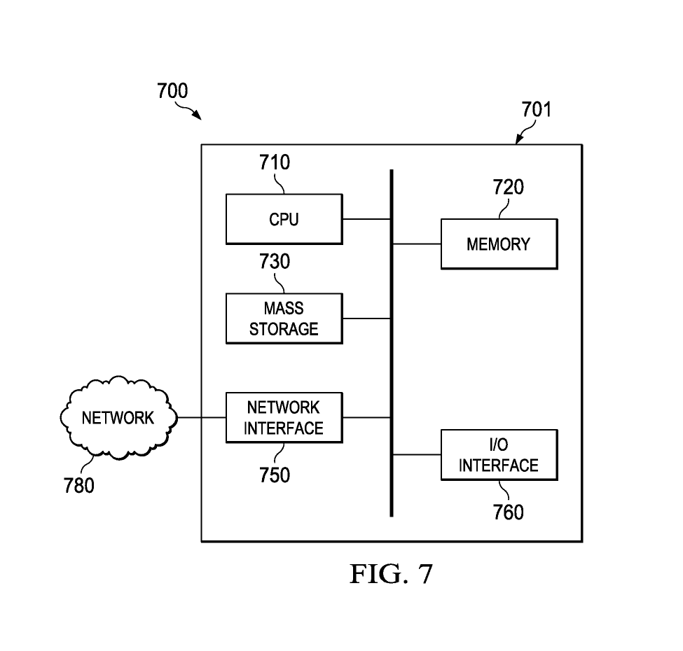

FIG. 7 is a block diagram of an exemplary processing system 700 that can be used to implement various embodiments. Specific devices may utilize all of the components shown, or only a subset of the components and levels of integration may vary from device to device. Furthermore, a device may contain multiple instances of a component, such as multiple processing units, processors, memories, transmitters, receivers, etc. The processing system 700 may comprise a processing unit 701 equipped with one or more input/output devices, such as a network interfaces, storage interfaces, and the like. The processing unit 701 may include a central processing unit (CPU) 710, a memory 720, a mass storage device 730, and an I/O interface 760 connected to a bus. The bus may be one or more of any type of several bus architectures including a memory bus or memory controller, a peripheral bus or the like.

The CPU 710 may comprise any type of electronic data processor. The memory 720 may comprise any type of system memory such as static random access memory (SRAM), dynamic random access memory (DRAM), synchronous DRAM (SDRAM), read-only memory (ROM), a combination thereof, or the like. In an embodiment, the memory 720 may include ROM for use at boot-up, and DRAM for program and data storage for use while executing programs. In embodiments, the memory 720 is non-transitory. The mass storage device 730 may comprise any type of storage device configured to store data, programs, and other information and to make the data, programs, and other information accessible via the bus. The mass storage device 730 may comprise, for example, one or more of a solid state drive, hard disk drive, a magnetic disk drive, an optical disk drive, or the like.

The processing unit 701 also includes one or more network interfaces 750, which may comprise wired links, such as an Ethernet cable or the like, and/or wireless links to access nodes or one or more networks 780. The network interface 750 allows the processing unit 701 to communicate with remote units via the networks 780. For example, the network interface 750 may provide wireless communication via one or more transmitters/transmit antennas and one or more receivers/receive antennas. In an embodiment, the processing unit 701 is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for dynamic image composition guidance, the method comprising:
determining, on a camera device, a geometric strength point according to an image composition rule for a scene captured on the camera device; and
guiding a user of the camera device while the camera device is moved to align an object of the scene with the geometric strength point before recapturing the scene on the camera device.

2. The method of claim 1 further comprising selecting the image composition rule from a plurality of available image composition techniques according to an input from the user.

3. The method of claim 1 further comprising selecting the image composition rule from a plurality of available image composition techniques according to settings on the camera device or image conditions.

4. The method of claim 1 further comprising:
determining a second geometric strength point according to the image composition rule; and
selecting, for aligning the object, the geometric strength point with a higher score according to the image composition rule.

5. The method of claim 1, wherein the object of the camera device is a focused object in the scene.

6. The method of claim 1, wherein the image composition rule is a rule of thirds, a golden spiral rule, or a golden triangles rule.

7. The method of claim 1, wherein the camera device is a smartphone or a computer tablet equipped with a digital camera.

8. A method for dynamic image composition guidance, the method comprising:
displaying, on a camera device, a first image captured for a scene;
determining, for the first image, a geometric strength point according to an image composition rule;
displaying the geometric strength point on the first image;
displaying an object point associated with a focused object on the first image;
displaying changes to the scene in accordance with movements of the camera device with respect to the scene; and
displaying a second image captured for the scene after the camera device is moved.

9. The method of claim 8, wherein displaying changes to the scene in accordance with movements of the camera device comprises displaying in real-time movement of the object point associated with the focused object with respect to the geometric strength point.

10. The method of claim 9, wherein the displayed geometric strength point is fixed with respect to the movements of the camera device.

11. The method of claim 8 further comprising displaying a template of the image composition rule on the first image, wherein the geometric strength point is located at an intersection of lines of the template.

12. The method of claim 11, wherein the displayed template is fixed with respect to the movements of the camera device.

13. The method of claim 8 further comprising:
determining a second geometric strength point according to the image composition rule;
displaying the second geometric strength point on the first image; and
highlighting, for aligning the focused object, the whichever geometric strength point has a higher score according to the image composition rule.

14. The method of claim 8 further comprising displaying in real-time a movement guider to guide a user of the camera device to align the focused object with the geometric strength point.

15. The method of claim 8, wherein the geometric strength point is displayed as a first geometric shape, and wherein the object point associated with the focused object is displayed as a second geometric shape.

16. The method of claim 8 further comprising displaying instructions to move the camera device to align the object point associated with the focused object with the geometric strength point.

17. A method for operating a camera device with dynamic image composition guidance, the method comprising:
capturing, on the camera device, a first image for a scene;
moving the camera device to align, on a screen of the camera device, an object point in the first image at or close to a geometric strength point fixed on the screen, wherein the object point and the geometric strength point are displayed while moving the camera, and wherein the geometric strength point is determined by the camera device according to an image composition rule; and
capturing a second image for the scene after aligning the object with the geometric strength point.

18. The method of claim 17 further comprising controlling movement of the camera device to align the object at or close to the geometric strength point according to movement guiding instructions or indicators displayed on the screen.

19. A device equipped with a camera and configured for dynamic image composition guidance, the device comprising:
at least one processor; and
a non-transitory computer readable storage medium storing programming for execution by the at least one processor, the programming including instructions to:
determine a geometric strength point according to an image composition rule for a scene captured by the camera; and
guide a user of the camera while the user moves the device to align an object of the scene with the geometric strength point before recapturing the scene on the device.

20. The device of claim 19, wherein the programming includes further instructions to:
display a first image captured for the scene before guiding the user to align the object;
display the geometric strength point on the first image;
display an object point associated with the object in the first image; and
display a second image captured for the scene after the camera is moved to align the object point with the geometric strength point.

21. The device of claim 20, wherein the programming includes further instructions to display a template of the image composition rule on the first image, and wherein the geometric strength point is located at an intersection of lines of the template.

22. The device of claim 19, wherein the instructions to guide the user to move the camera comprises instructions to display in real-time movement of an object point associated with the object with respect to the geometric strength point, and wherein the geometric strength point is fixed with respect to movements of the camera.

23. The device of claim 19, wherein the instructions to guide the user to move the camera comprise instructions to display in real-time a movement guider to guide the user to move the object at or close to the geometric strength point.

24. The device of claim 19, wherein the instructions to guide the user to move the camera comprise instructions to display a message to move the camera to align an object point associated with the object with the geometric strength point.
